(19) United States
(12) Patent Application Publication
(10) Pub. No.: US 2007/0219098 A1
(43) Pub. Date: Sep. 20, 2007

(54) EMULSIFIERS FOR DRILLING FLUIDS

(76) Inventors: Heinz Mueller, Monheim (DE); Nadja Herzog, Kerschenbroich (DE); Jens Hartmann, Bidnija (MT)

Correspondence Address: COGNIS CORPORATION;PATENT DEPARTMENT, 300 BROOKSIDE AVENUE, AMBLER, PA, 19002, US

(21) Appl. No.: 10/595,280

(22) PCT Filed: Oct. 15, 2004
(86) PCT No.: PCT/EP04/11623

§ 371 Date: Jan. 18, 2007

(30) Foreign Application Priority Data
Oct. 24, 2003 (DE) 103 49 807.9

(51) Int. Cl. C09K 8/524

(52) U.S. Cl. 507/116; 507/218

(57) ABSTRACT

The invention relates to the use of surfactant mixtures containing alkyl oligoglycosides and alkenyl oligoglycosides (APG) of formula (1), RO-[G]p, in which R represents an alkyl and/or alkenyl radical comprising between 4 and 22 carbon atoms, G represents a sugar radical comprising 5 or 6 carbon atoms and p represents numbers from 1 to 10, mixed with free fatty acids comprising between 6 and 22 C atoms. Preferably, said mixtures are suitable for use as emulsifiers for invert drilling-fluid systems.

The invention relates generally to additives for well servicing compositions and, more particularly, to emulsifiers for water-based emulsion drilling fluids and to drilling fluid systems containing these emulsifiers.

It is nown that drilling fluids for sinking wells in rock and bringing up the rock cuttings are flowable water- or oil-based systems that are thickened to a limited extent. Oil-based systems are acquiring increasing significance in practice and are used in particular in offshore drilling operations. Oil-based drilling fluids are generally used as so-called invert emulsion muds which consist of a 3-phase system: oil, water and fine-particle solids. Drilling fluids such as these are preparations of the w/o emulsion type, i.e. the aqueous phase is heterogenerously and finely dispersed in the continuous oil phase. A range of additives may be used for stabilizing the system as a whole and for establishing the required performance properties, including in particular emulsifiers and emulsifier systems, weighting agents, fluid loss additives, viscosity adjusters and optionally an alkali reserve.

A key criterion for evaluating the usefulness of invert drilling fluids in practice are their rheological characteristics. Certain viscosity values have to be maintained in drilling fluid systems suitable for practical application. In particular, uncontrolled thickening and hence increases in the viscosity of the drilling fluid have to be strictly prevented because, otherwise, the pipe can become stuck during drilling and can only be freed by expensive, time-consuming measures. In practice, therefore, suitable diluents are added to the drilling fluid systems before and also during drilling. It is known that anionic surfactants from the group of fatty alcohol sulfates, fatty alcohol ether sulfates and alkyl benzenesulfonates are preferably used for this purpose. In addition, it is important to ensure that the drilling fluid which is pumped into the ground is heated, for example, to temperatures of 150 to 250° F. (66 or 121° C.), depending on the depth and—in the case of very deep wells—to temperatures of up to 350° F. (178° C.), although it is not always desirable for the rheology of the drilling fluid at high temperatures to be influenced at the same time. Instead, only selecting influencing in the critical low temperature range is desirable in many cases. In addition, all additives and auxiliaries used in offshore and onshore drilling fluid systems are expected to satisfy stringent biodegradability and toxicity requirements. Also, the ambient conditions prevailing during drilling operations, such as high temperatures, high pressures, changes in pH caused by the inrush of acidic gases, etc., impose high demands on the choice of possible components and additives.

If water-based drilling fluid systems in emulsion form are used, as is often the case, the presence of emulsion is essential. A large number of suitable compounds are known to the expert, for example from the disclosure of EP 0 948 577, of which the technical teaching is confined to special temperature-depending emulsions. However, a large number of emulsifiers suitable for use in drilling fluids are mentioned in that document cf. the disclosure of paragraphs 0066 to 0076 of EP 0 948 577 B1. The choice of emulsifiers for well servicing systems and, more particularly, drilling fluids is primarily directed at finding substances which lead to maximum stability of the emulsion, even under the extreme conditions of practical application, i.e. and increase in the viscosity of the drilling fluid and, more particularly, breaking of the emulsion should be strictly prevented. This applies in particular to emulsions of the water-in-oil type.

In addition, a key function of the drilling fluid is to stabilize the cavity formed by drilling against the inrush of liquids from the formation. This is achieved by the pressure of the fluid being greater than the pressure of the formation liquids. However, the drilling fluid thus also tends to penetrate into the formulation, although solids present in the fluid rapidly form a layer (so-called filter cake) on the surface of the bore wall which only allows small quantities of liquid through. The quantity of liquid thus lost should be kept to a minimum, so that the filtrate volume (as measured to API) is a key criterion for the quality of a drilling fluid. Accordingly, there is an ongoing search for systems which improve the filtrate values of drilling fluids without adversely affecting the other properties demanded of them.

It has now been found that the problem stated above can be solved by the use of certain surfactant mixtures.

Accordingly, the present invention relates to the use of surfactant mixtures containing alkyl and alkenyl oligoglycosides (APGs) corresponding to formula (I):
RO-[G]ₚ (I)
in which R is an alkyl and/or alkenyl group containing 4 to 22 carbon atoms, G is a sugar unit containing 5 or 6 carbon atoms and p is a number of 1 to 10,
in admixture with free fatty acids containing 6 to 22 carbon atoms as an additive in drilling fluids.

The use of APGs as an emulsifier in drilling fluids is known from WO 92/02594. Alkyl (oligo)glycosides of the type claimed herein may be obtained by the relevant methods of preparative organic chemistry. The alkyl and/or alkenyl oligoglycosides may be derived from aldoses or ketoses containing 5 or 6 carbon atoms, preferably glucose. Accordingly, the preferred alkyl and/or alkenyl oligoglycosides are alkyl and/or alkenyl oligoglucosides. The index p in general formula (I) indicates the degree of oligomerization (DP), i.e. the distribution of mono- and oligoglycosides, and is a number of 1 to 10. Whereas p in a given compound must always be an integer, and, above all, may assume a value of 1 to 6, the value p for a certain alkyl oligoglycoside is an analytically determined calculated quantity which is generally a broken number. Alkyl and/or alkenyl oligoglycosides having an average degree of oligomerization p of 1.1 to 3.0 are preferably used. Alkyl and/or alkenyl oligoglycosides having a degree of oligomerization of less than 17 and, more particularly, between 1.2 and 1.4 are preferred from the application perspective. The alkyl or alkenyl group R¹ may be derived from primary alcohols containing 4 to 11 and preferably 8 to 10 carbon atoms. Typical examples are butanol, caproic alcohol, caprylic alcohol, capric alcohol and undecyl alcohol and the technical mixtures thereof obtained, for example, in the hydrogenation of technical fatty and methyl esters or in the hydrogenation of aldehydes from Roelen's oxosynthesis. Alkyl oligoglycosides having a chain length of C₈ to C₁₀ (DP=1 to 3), which are obtained in as first runnings in the separation of technical C₈₋₁₆ coconut oil fatty alcohol by distillation and which may contain less than 6% by weight of C₁₂ alcohol as an impurity, and also alkyl oligo-glucosides based on technical C_{9/11} oxoalcohols (DP=1 to 3) are preferred. In addition, the alkyl or alkenyl group R¹ may also be derived from primary alcohols containing 12 to 22, preferably 12 to 18 and more particularly 12 to 14 carbon atoms. Typical examples are lauryl alcohol, myristyl alcohol, cetyl alcohol, palmitolelyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol, brassidyl alcohol and technical mixtures thereof which may be obtained as described above. Alkyl oligoglucosides based on hydrogenated C_{12/14} coconut oil fatty alcohol having a DP of 1 to 3 are preferred. Besides the APGs described above, fatty alcohols from the production process may also be present in the APGs to be used.

However, a key value of the claimed systems is that the APGs are used in combination with free fatty acids, preferably those corresponding to the general formula R′-COOH, in which R′ is a saturated or unsaturated, branched or unbranched alkyl or alkenyl group containing 11 to 21 carbon atoms. In a particularly advantageous embodiment, the APGs are combined with fatty acids corresponding to the above formula, in which R′ is an unbranched alkyl or alkenyl group containing 11 to 21 carbon atoms. Besides the free fatty acids, salts thereof may also be used for the purposes of the invention. In a preferred embodiment, the C chain length of the free fatty acids is identical with the C chain length of R in formula (I) for the APGs. Mixtures of APGs and/or mixtures of free fatty acids may also be used together within the scope of the technical teaching disclosed herein.

The fatty acids should preferably be used in quantities of at least 0.1% by weight, more preferably at least 0.3% by weight and advantageously from 0.5 to 10% by weight, based on the weight of the drilling fluid. A particularly preferred range is from 1.0 to 5.0% by weight. The free fatty acids should preferably be used in quantities of 1.5 to 6% by weight, based on the weight of the oil phase. In another preferred embodiment, the free fatty acids and the surfactant mixtures are used in a ratio by weight of ca. 1:1 and preferably 2:1 to at most 10:1, based on active substance.

The surfactant mixtures are preferably used as emulsifiers in drilling fluids, the drilling fluid having to contain at least one aqueous and one non-aqueous phase. In a particularly preferred embodiment, the surfactant mixtures are used as emulsifiers in drilling fluids which form a water-in-oil or oil-in-water emulsion. In a most particularly preferred embodiment, the surfactant mixtures are used for so-called invert drilling fluids where a water phase is “dispersely” emulsified in a continuous oil phase. It can be of advantage to use the surfactant mixtures according to the invention in such drilling fluids, in which case the oil phase of the drilling fluids is selected from esters of saturated or unsaturated, branched or unbranched monocarboxylic acids containing 1 to 24 carbon atoms and monohydric, linear or branched, saturated or unsaturated alcohols containing 1 to 24 carbon atoms. The surfactant mixtures are also preferably used in drilling fluids of which the oil phase contains linear α-olefins, internal olefins or paraffins. It can also be of advantage to use oil phases consisting of mixtures of the preferred carrier fluids described above.

The drilling fluids according to the invention should contain the surfactant mixtures in quantities of preferably at least 0.05% by weight, based on the total weight of the drilling fluid. In a preferred embodiment, the surfactant mixtures are used in quantities of 0.1 to at most 25% by weight, preferably 0.1 to 10% by weight and more preferably 0.1 to 5% by weight, based on the weight of the drilling fluid as a whole, in order to be able optimally to develop their effect according to the invention. The range from 0.1 to 1.0% by weight is most particularly preferred. Based on the weight of the oil phase alone, the surfactant mixtures should preferably be used in a quantity of 1 to 15% by weight, the range from 1 to 10% by weight being particularly preferred.

The use of the surfactant mixtures according to the invention leads to an improvement in the rheological properties of the emulsions, particularly in respect to their filtrate properties. Another positive effect of using the surfactant mixtures in drilling fluids is that the drilling fluids retain their rheological properties, even in the event of contamination, and do not, for example, undergo an unfavorable increase in yield point.

The present invention also relates to well servicing compositions, more particularly drilling fluids, flowable and pumpable at 5 to 20° C. which are based either on a continuous oil phase, optionally in admixture with a limited quantity of a disperse aqueous phase (w/o invert type), or on an o/w emulsion with a disperse oil phase in the continuous aqueous phase and which optionally contain dissolved and/or dispersed standard auxiliaries, such as thickeners, emulsifiers, fluid loss additives, wetting agents, fine-particle weighting agents, salts, alkali reserves and/or biocides, characterized in that, in their oil phase, they contain compounds selected from the following classes:
(a) carboxylic acid esters corresponding to formula (II):
   R′—COOR—R″ (II)
   where R′ is a saturated or unsaturated, linear or branched C₅₋₂₂ alkyl group and R″ is a C_{1/22} alkyl group which may be saturated or unsaturated, linear or branched,
(b) linear or branched C₈₋₃₀ olefins,
(c) water-insoluble, symmetrical or nonsymmetrical ethers of monohydric alcohols of natural or synthetic origin which may contain 1 to 24 carbon atoms,
(d) water-insoluble alcohols corresponding to formula (III):
   R′″—OH (III)
   wherein R′″ is a saturated, unsaturated, linear or branched C₈₋₂₄ alkyl group,
(e) carbonic and diesters,
(f) parrafins,
(g) acetals.

In a particularly preferred embodiment, the oil phase is formed by the carboxylic acid esters of formula (II), more particularly those described in EP 0 374 672 or EP 0 386 636. In another particularly preferred embodiment, the compounds of formula (I) are used in invert drilling fluid emulsions of which the oil phase (A) contains esters of formula (II), in which R′ is an alkyl group containing 5 to 21 carbon atoms, preferably 5 to 17 carbon atoms and more particularly 11 to 17 carbon atoms. Particularly suitable alcohols in such esters are based on branched or unbranched alcohols containing 1 to 8 carbon atoms, for example on methanol, isopropanol, isobutanol or 2-ethylhexanol. Alcohols containing 12 to 18 carbon atoms are also preferred. Particularly preferred esters are saturated C₁₂₋₁₄ fatty acid esters or unsaturated C₁₆₋₁₈ fatty acids with isopropyl, isobutyl or 2-ethylhexanol as the alcohol component. 2-Ethylhexyl octanoate is also suitable. Other suitable esters are acetic acid esters, particularly acetates of C₈₋₁₀ fatty alcohols. Oil phases such as these—normally called carrier fluids—are known, for example, from earlier Cognis patents/patent applications, cf. in particular European patent applications EP 0 374 671, EP 0 374 672, EP 0 382 070, EP 0 386 638. Oil phases based on linear olefins are also known to the expert, cf. EP-A-0 765 368. Branched esters (a) as disclosed, for example in WO 99/33932 (Chevron) or in EP 0 642 561 (Exxon) are also suitable carrier fluids in the process according to the invention; the esters disclosed therein are part of the disclosure of the present invention. Mixtures of these preferred esters with one another are also preferred. In another preferred embodiment, the oil phase contains α-olefins or internal olefins (IOs) or poly-α-olefins (PAOs) as component (b). The IOs or IO mixtures present in the oil phase according to the invention then contain corresponding compounds with 12 to 30 carbon atoms in the molecule, preferably 14 to 24 carbon atoms and more particularly up to 20 carbon atoms in the molecule. If α-olefins are present as the oil phase, α-olefins based on fatty acids containing 12 to 18 carbon atoms are preferably used, saturated α-olefins being particularly preferred. These preferred mixtures are the subject of applicants' EP 0 765 368 A1. Other suitable constituents of the oil phase are water-insoluble symmetrical or nonsymmetrical ethers (c) of monohydric alcohols of natural or synthetic origin, the alcohols containing from 1 to 24 carbon atoms. Corresponding drilling fluids are the subject of European patent application EP 0 472 557. Water-soluble alcohols of group (d) can also be preferred constituents of the oil phase. The same applies to carbonic acid diesters (e) according to European patent application EP 0 532 570. These compounds can make up the oil phase as a whole or parts thereof. Paraffins (f) and/or acetals (g) may also be used as constituents of the oil phase.

Mixtures of compounds (a) to (g) with one another may also be used. In a preferred embodiment, at least 50% by weight of the oil phase of the emulsions according to the invention consists of such preferred compounds (a) to (g), systems in which 60 to 80%, and more particularly 100% by weight of the oil phase consists of compounds (a) to (g) or mixtures thereof being particularly preferred. The oil phases themselves then preferably have flash points above 85° C. and preferably above 100° C. They are formulated in particular as invert drilling fluids of the w/o type and preferably contain the disperse aqueous phase in quantities of about 5. In water-based o/w emulsion fluids, the quantity of disperse oil phase is in the range from about 1 to 50% by weight and preferably in the range from about 8 to 50% by weight. The continuous oil phases of such drilling fluids according to the invention have a Brookfield (RVT) viscosity of 0 to 5° C. of below 50 mPa.s and preferably not above 40 mPa.s. The pH of the fluids is preferably adjusted to a value in the range from about neutral to moderately basic and, more particularly, to a value in the range from about 7.5 to 11; the use of lime as an alkali reserve can be particularly preferred.

Water is also a constituent of the described drilling fluids. The water is preferably present in the invert emulsions in quantities of at least about 0.5% by weight. In a preferred embodiment, however, the invert emulsions contain at least 5 to 10% by weight of water. The water in drilling fluid systems of the type described herein always contains quantities of electrolytes to equalize the osmotic gradient between the drilling fluid and the formation water, calcium and/or sodium salts representing the preferred electrolytes. CaCl₂ in particular is commonly used. However, other salts from the group of alkali metals and/or alkaline earth metals, for example potassium acetates and/or formates, are also suitable.

According to the invention, the surfactant mixtures are preferably used as emulsifiers in drilling fluid systems which, based on the liquid phase as a whole, contain 10 to 30% by weight water and hence 90 to 70% by weight of the oil phase. On account of the high percentage of dispersed solids in invert drilling fluids, reference is not made here to the weight of the fluid as a whole, i.e. water, oil and solid phases. The surfactant mixtures are oil-soluble and, accordingly, are predominantly present in the oil phase and the interfaces thereof with the water phase.

Other preferred mixing ratios are 80% by weight oil phase to 20% by weight water phase. The drilling fluids according to the invention may also contain other typical additives and auxiliaries such as, in particular, other emulsifiers, weighting agents, fluid loss additives, thickeners, and alkali reserves, more particularly lime (═Ca(OH)₂), and also biocides and so-called wetting agents which improve the wettability of surfaces.

Emulsifiers suitable for use in practice are systems which are suitable for forming the required w/o emulsifiers. Besides the systems according to the invention, other compounds known to the expert may also be used, including in particular selected oleophilic fatty acid salts based on amidoamine compounds. However, the drilling fluids preferably contain no other emulsifiers.

Emulsifiers of the type in question here are marketed as highly concentrated active-component preparations and may be used, for example, in quantities of about 2.5 to 5% by weight and, more particularly, in quantities of ca. 3 to 4% by weight, based on oil phase.

In practice, hydrophobicized lignite in particular is used as a fluid loss additive and, hence, in particular to form a dense coating in the form of a substantially liquid-impermeable film on the walls of the well. Suitable quantities are, for example, about 5 to 20 lb/bbl, preferably 5 to 10 lb/bbl and more particularly 5 to 8% by weight, based on the oil phase.

In drilling fluids of the type in question here, the thickener normally used is a cationically modified fine-particle bentonite which may be used in particular in quantities of ca. 8 to 10 and preferably 2 to 5 lb/bbl or in the range from 1 to 4% by weight, based on oil phase. The weighting agent normally used to establish the necessary pressure equilibrium is barite (BaSO₄), of which the quantities added are adapted to the particular conditions to be expected in the well. For example, the specific gravity of the drilling fluid can be increased by addition of barite to values of up to about 2.5 and preferably in the range from ca. 1.3 to 1.6. Another suitable weighting agent is calcium carbonate.

### EXAMPLES

### Example 1

To test the present technical teaching, drilling fluids with the following general composition were prepared:

| | | |
|---|---|---|
| oil phase¹⁾ | 173 | ml |
| water | 77 | ml |
| thickener²⁾ | 2 | g |
| Ca(OH)₂ | 2 | g |
| barium sulfate | 327 | g |
| CaCl₂•2H₂O | 27 | g |
| oil-to-water ratio | 70:30 | (v/v) |
| density | 14 | lb/gal (1.7 g/l) |

¹⁾C₁₆₋₁₈-α-olefin, isomerized (Chevron); density at 20° C.: 0.785 g/cm³, Brookfield (RVT) viscosity at 20° C. 5.5 mPa · s
²⁾modified organophilic bentonite, Geltone II (Baroid)

Mixtures of APGs with fatty acids were added as emulsifiers to the drilling fluids. All systems A to E contained 2 g (active substance) of a mixture of an APG corresponding to formula (I), where G is a glucose unit, p is a number of 1.2 and R stands for mixtures of C_{12/14} alkyl groups, with 2 g fatty acids. System A contained hexanoic acid, B decanoic acid, C undecanoic acid, D tetradecanoic acid, E palmitic acid, F stearic acid, G oleic acid, H behenic acid, I sodium oleate and J potassium oleate. The constituents were mixed in the following order in a Hamilton mixer: oil phase, water, thickener, emulsifier, lime, barium sulfate and then the calcium chloride.

The results of the rheological measurements can be found in Tables 1a and 1b. They show that the combination of APG with relatively long-chain fatty acids in particular leads to the best filtrate values.

TABLE 1a

| | | System No.: | | | | | | | | | |
|---|---|---|---|---|---|---|---|---|---|---|---|
| | | A | | B | | C | | D | | E | |
| | | BHR | AHR | BHR | AHR | BHR | AHR | BHR | AHR | BHR | AHR |
| Hours | h | | 16 | | 16 | | 16 | | 16 | | 16 |
| rolled/aged | | | | | | | | | | | |
| Hot roll | ° F. | | 250 | | 250 | | 250 | | 250 | | 250 |
| temp. | | | | | | | | | | | |
| Electrical | V | 290 | 310 | 260 | 260 | 300 | 300 | 250 | 240 | 260 | 250 |
| stability | | | | | | | | | | | |
| 600 rpm | sd | 80 | 68 | 73 | 72 | 76 | 67 | 80 | 67 | 84 | 67 |
| 300 rpm | | 47 | 37 | 43 | 40 | 47 | 36 | 50 | 34 | 54 | 37 |
| 200 rpm | | 35 | 27 | 33 | 29 | 37 | 27 | 39 | 25 | 43 | 28 |
| 100 rpm | | 23 | 17 | 21 | 18 | 26 | 17 | 26 | 15 | 30 | 17 |
| 6 rpm | | 7 | 4 | 7 | 4 | 9 | 5 | 9 | 3 | 12 | 6 |
| 3 rpm | | 6 | 3 | 6 | 3 | 8 | 4 | 8 | 2 | 11 | 5 |
| PV | cP | 33 | 31 | 30 | 32 | 29 | 31 | 30 | 33 | 30 | 30 |
| YP | lb/100 ft² | 14 | 6 | 13 | 8 | 18 | 6 | 20 | 1 | 24 | 7 |
| Gels 10″/10′ | lb/100 ft² | 8/17 | 4/9 | 6/17 | 5/15 | 8/13 | 4/10 | 8/19 | 4/11 | 9/14 | 3/9 |
| HTHP total | ml | | 7.9 | | 3 | | 3.4 | | 1.8 | | 1.9 |
| HTHP Temp. | ° F. | 250 | 250 | 250 | 250 | 250 | 250 | 250 | 250 | 250 | 250 |

TABLE 1b

| | | System No.: | | | | | | | | | |
|---|---|---|---|---|---|---|---|---|---|---|---|
| | | F | | G | | H | | I | | J | |
| | | BHR | AHR | BHR | AHR | BHR | AHR | BHR | AHR | BHR | AHR |
| Hours | h | | 16 | | 16 | | 16 | | 16 | | 16 |
| rolled/aged | | | | | | | | | | | |
| Hot roll | ° F. | | 250 | | 250 | | 250 | | 250 | | 250 |
| temp. | | | | | | | | | | | |
| Electrical | V | 260 | 260 | 400 | 400 | 390 | 440 | 280 | 380 | 360 | 340 |
| stability | | | | | | | | | | | |
| 600 rpm | sd | 94 | 66 | 78 | 58 | 87 | 61 | 76 | 60 | 75 | 60 |
| 300 rpm | | 59 | 36 | 47 | 32 | 51 | 32 | 45 | 34 | 44 | 33 |
| 200 rpm | | 47 | 27 | 37 | 25 | 39 | 24 | 34 | 25 | 34 | 24 |
| 100 rpm | | 32 | 17 | 26 | 17 | 27 | 16 | 23 | 16 | 23 | 15 |
| 6 rpm | | 13 | 4 | 10 | 8 | 11 | 6 | 8 | 5 | 10 | 4 |
| 3 rpm | | 12 | 3 | 8 | 6 | 8 | 5 | 7 | 4 | 8 | 3 |
| PV | cP | 35 | 30 | 31 | 26 | 36 | 29 | 31 | 26 | 31 | 27 |
| YP | lb/100 ft² | 24 | 6 | 16 | 6 | 15 | 3 | 14 | 8 | 13 | 6 |
| Gels 10″/10′ | lb/100 ft² | 14/31 | 4/9 | 8/8 | 4/5 | 5/9 | 2/4 | 7/10 | 5/6 | 6/7 | 5/5 |
| HTHP total | ml | | 3.5 | | 1 | | 0.4 | | 2.1 | | 1.6 |
| HTHP Temp. | ° F. | 250 | 250 | 250 | 250 | 250 | 250 | 250 | 250 | 250 | 250 |

sd = scale divisions on the viscosimeter

1-12. (canceled)

13. A drilling fluid additive which comprises: a surfactant mixture comprising at least one of an alkyl oligoglycoside and an alkenyl oligoglycoside (APGs) of the formula:
RO-[G]ₚ (I)
in which R is an alkyl and/or alkenyl group containing 4 to 22 carbon atoms, G is a sugar unit containing 5 to 6 carbon atoms and p is a number of 1 to 10, in admixture with a free fatty acid containing 6 to 22 carbon atoms.

14. The drilling fluid additive of claim 13, wherein, the fatty acid comprises a compound of the formula R′—COOH, in which R′ is a saturated or unsaturated, branched or unbranched aliphatic group containing 11 to 21 carbon atoms.

15. The drilling fluid additive of claim 14, wherein, the mixture comprises an APG of formula (I) with an unsaturated fatty acid of the formula R′-COOH.

16. The drilling fluid additive of claim 13, wherein, a weight ratio of the free fatty acid to the APC of formula (I) is from about 1:1 to at most 10:1.

17. A drilling fluid emulsion which comprises at least one aqueous phase and at least one nonaqueous phase wherein an emulsifier comprises the drilling fluid additive of claim 13.

18. The drilling fluid of claim 17, wherein, the drilling fluid comprises a water-in-oil or oil-in-water emulsion.

19. The drilling fluid of claim 18, wherein, an oil phase of the drilling fluid comprises esters of saturated or unsaturated, branched or unbranched monocarboxylic acids containing 1 to 24 carbon atoms with monohydric, linear or branched, saturated or unsaturated alcohols containing 1 to 24 carbon atoms.

20. The drilling fluid of claim 17 which comprises a water-based emulsion drilling fluid which contains at least one member selected from the group consisting of linear α-olefins, internal olefins and paraffins in the oil phase.

21. The drilling fluid of claim 17, wherein, the drilling fluid additive is present in a quantity of 0.1% to 25% by weight, based on a weight of a liquid portion of the drilling fluid.

22. An invert drilling fluid wherein the emulsifier comprises the drilling fluid additive of claim 13.

23. A well servicing composition flowable and pumpable at 5° C. to 20° C. which comprises a continuous oil phase in admixture with a disperse aqueous phase which contains dissolved and/or dispersed therein at least one standard auxiliary selected from the group consisting of thickeners, fluid loss additives, wetting agents, fine-particle size weighting agents, salts, alkali reserves biocides, and the drilling fluid additive of claim 13.

24. The well servicing composition as claimed in claim 23, wherein, the oil phase comprises at least one member selected from the group consisting of
(a) carboxylic acid esters of formula:
R′—COO—R″ (II)
where R′ is a saturated or unsaturated, linear or branched C₅₋₂₃ alkyl group and R″ is a C₁₋₂₂ alkyl group which may be saturated or unsaturated, linear or branched,
(b) linear or branched C₈₋₃₀ olefins,
(c) water-insoluble, symmetrical or nonsymmetrical ethers of monohydric alcohols of natural or synthetic origin which contain 1 to 24 carbon atoms,
(d) water-insoluble alcohols of formula:
R′″—OH (III)
wherein R′″ is a saturated, unsaturated, linear or branched C₈₋₂₄ alkyl group,
(e) carbonic acid diesters,
(f) paraffins, and
(g) acetals.

25. The drilling fluid additive of claim 16, wherein, the weight ratio of free fatty acid to APG is from about 1:1 to about 2:1.

26. The drilling fluid of claim 21, wherein, the drilling fluid additive is present at from 0.1% to 10% by weight.

27. The drilling fluid of claim 21, wherein, the drilling fluid additives is present at from 0.1% to 5.0% by weight.
